(19) United States
(12) Patent Application Publication
(10) Pub. No.: US 2018/0142637 A1
(43) Pub. Date: May 24, 2018

(54) METHOD FOR STARTING ENGINE

(71) Applicants: Hyundai Motor Company, Seoul (KR); Kia Motors Corporation, Seoul (KR)

(72) Inventor: Sun Myoung JO, Yeoju-si (KR)

(73) Assignees: Hyundai Motor Company, Seoul (KR); Kia Motors Corporation, Seoul (KR)

(21) Appl. No.: 15/789,737

(22) Filed: Oct. 20, 2017

(30) Foreign Application Priority Data
Nov. 23, 2016 (KR) 10-2016-0156629

(51) Int. Cl. F02D 41/06

(52) U.S. Cl. CPC F02D 41/062; F02N 11/08

(57) ABSTRACT

A method for starting an engine may include determining whether an engine starting signal is applied, determining whether the engine is stopped by measuring a revolution per minute of a crankshaft through a crankshaft position detector when the engine starting signal is determined as being applied, and starting the engine when the engine is determined as being stopped.

### CROSS-REFERENCE TO RELATED APPLICATION

The present application claims priority to Korean Patent Application No. 10-2016-0156629, filed on Nov. 23, 2016, the entire contents of which is incorporated herein for all purposes by the present reference.

### BACKGROUND OF THE INVENTION

### Field of the Invention

The present invention relates to a method for starting an engine.

### Description of Related Art

FIGS. 1A and 1B are view illustrating a method for starting an engine according to the related art.

In general, as illustrated in FIGS. 1A and 1B, an engine 10 is started as the engine 10 is rotated by a starter motor 30 after a pinion gear 40 of the starter motor 30 is engaged with a ring gear 20 of the engine 10 when an engine starting signal is applied.

When the engine 10, which is started as described above, is stopped, inertia acts on the engine 10 and induces the engine 10 to continuously rotate. Accordingly, predetermined time is required to overcome the influence by the inertia and completely stop the engine 10.

However, an engine starting signal may be applied within a predetermined time after a time point at which an engine stopping signal is applied. According to the related art, in an engine stopping method, the starting time point of the engine 10 is determined without taking into consideration that the engine 10 is rotated due to inertia. According to the engine starting method of the related art, when the engine starting signal is applied while the engine 10 is rotating due to inertia, the pinion gear 40 of the starter motor 30 collides with the ring gear 20 of the engine 10 which is rotating. Therefore, according to the engine starting method of the related art, noise is caused due to the collision, and the durability of the starter motor 30 and the engine 10 deteriorates.

The information disclosed in the present Background of the Invention section is only for enhancement of understanding of the general background of the invention and may not be taken as an acknowledgement or any form of suggestion that the present information forms the prior art already known to a person skilled in the art.

### BRIEF SUMMARY

Various aspects of the present invention are directed to providing a method for starting an engine, which is improved to prevent the engine from colliding with a starter motor when the engine starts.

Further, an aspect of the present invention is to provide a method for starting an engine, which is improved to prevent the engine from being started while the engine is rotating due to inertia.

The technical problems to be solved by the present invention are not limited to the aforementioned problems, and any other technical problems not mentioned herein will be clearly understood from the following description by those skilled in the art to which the present invention pertains.

According to various aspects of the present invention, a method for starting an engine may include determining whether an engine starting signal is applied, determining whether the engine is stopped by measuring a revolution per minute of a crankshaft through a crankshaft position detector when the engine starting signal is determined as being applied, and starting the engine when the engine is determined as being stopped.

Preferably, the determining of whether the engine starting signal is applied may be performed by determining whether a brake pedal is in an off state when the engine enters an idle stop and go mode.

Preferably, the determining of whether the engine starting signal is applied may be performed by determining whether a key of the engine is switched to a key-on state, when the key of the engine is in a key-off state.

Preferably, the determining of whether the engine is stopped may include determining whether rotation of the crankshaft is stopped by measuring the revolution per minute of the crankshaft through the crankshaft position sensor, and maintaining a standby state for a delay time when the crankshaft is determined as being under rotation.

Preferably, the determining of whether the rotation of the crankshaft is stopped may include determining the crankshaft as being stopped when the revolution per minute of the crankshaft is less than a reference revolution per minute.

Preferably, the determining of whether the rotation of the crankshaft is stopped and the maintaining of the standby state for the delay time may be repeatedly performed until the rotation of the crankshaft is determined as being stopped, and the starting of the engine may be performed when the rotation of the crankshaft is determined as being stopped.

Preferably, the determining of whether the rotation of the crankshaft is stopped may be performed by additionally measuring a rotation direction of the crankshaft through the crankshaft position sensor.

Preferably, the crankshaft position detector may output a pulse signal having a period proportional to the revolution per minute, and the pulse signal output from the crankshaft position detector may have a pulse width, which is formed when the rotation direction of the crankshaft is a reverse direction, wider than a pulse width which is formed when the rotation direction of the crankshaft is a forward direction thereof.

Preferably, the delay time may be 50 ms.

As described above, according to the present invention, in the method of starting the engine, the engine is not instantly started even though the engine starting signal is applied, but is started after the engine is in the standby state until the engine is determined as being completely stopped. Therefore, according to the present invention, the method for starting the engine may prevent noise caused by the collision between the engine and the starter motor when the engine is started, and prevent the durability of the engine and the starter motor from being deteriorated.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1A and 1B are sectional views illustrating an engine starting method, according to the related art;

FIG. 2 is a flowchart illustrating a method for starting an engine, according to an embodiment of the present invention;

FIG. 3 is a block diagram illustrating a control system of the engine;

FIG. 4 is a sectional view illustrating a crank shaft position sensor;

FIG. 5A, FIG. 5B, FIG. 6A and FIG. 6B are views illustrating an operation of determining whether an engine is stopped, by use of the crank shaft position detector illustrated in FIG. 4; and

FIG. 7 is a graph illustrating an aspect of starting the engine in the method for starting an engine, according to an embodiment of the present invention.

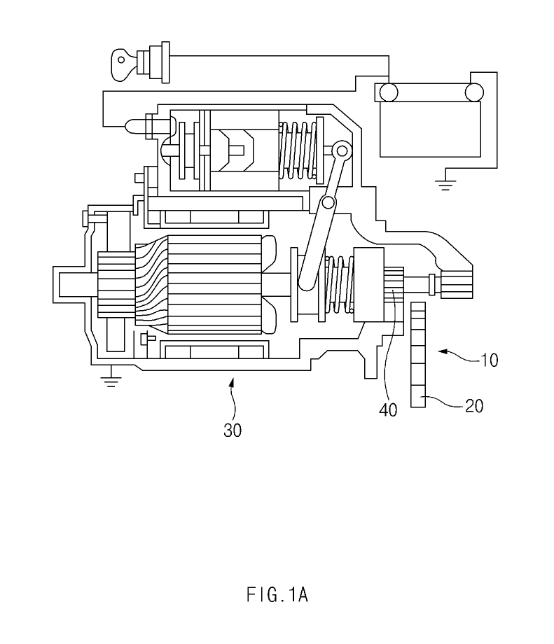

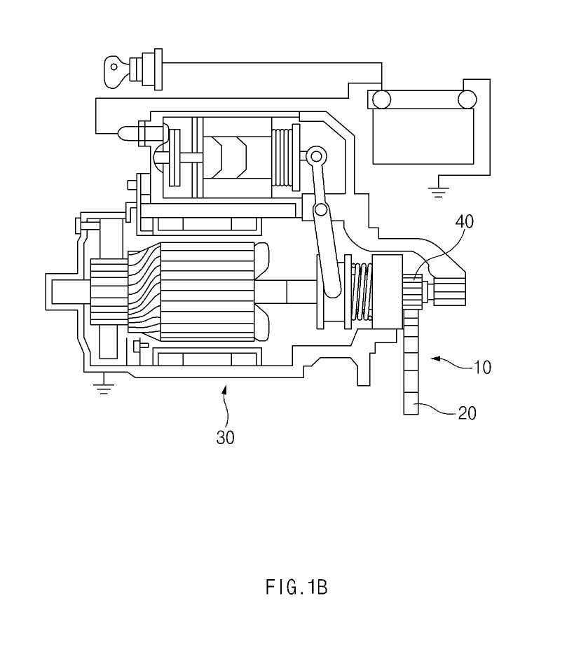

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Terms and words used in the specification and the claims shall not be interpreted as commonly-used dictionary meanings, but shall be interpreted as to be relevant to the technical scope of the invention based on the fact that the inventor may properly define the concept of the terms to explain the invention in best ways. Accordingly, the embodiments and the configurations depicted in the drawings are illustrative purposes only and do not represent all technical scopes of the embodiments, so it may be understood that various equivalents and modifications may exist at the time point of filing the present application.

The size of each of elements and the size of a specific part of the element, which are shown in accompanying drawings, may be exaggerated, omitted or schematically drawn for convenience or clarity. In addition, the size of elements does not utterly reflect an actual size. In the following description, detailed descriptions of functions or configurations of well-known elements will be ruled out in order not to unnecessarily obscure the gist of the present invention.

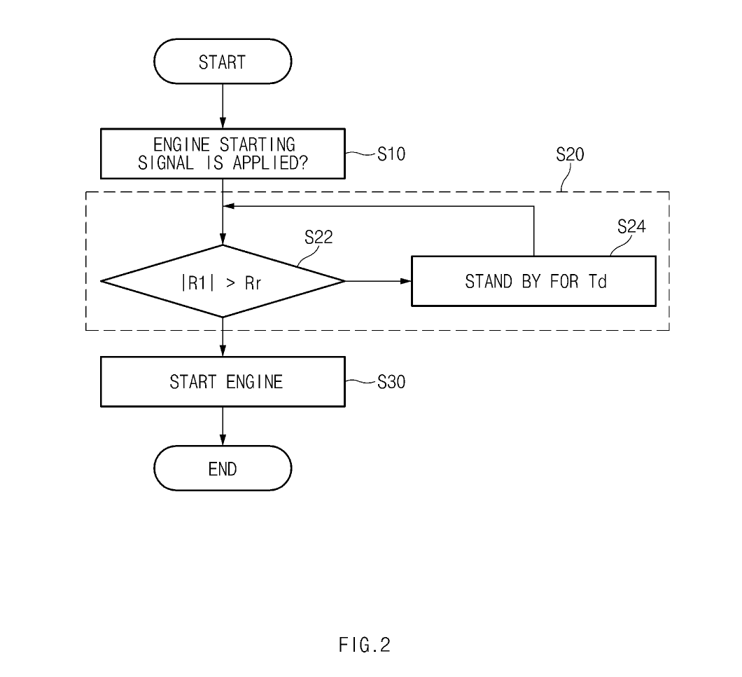

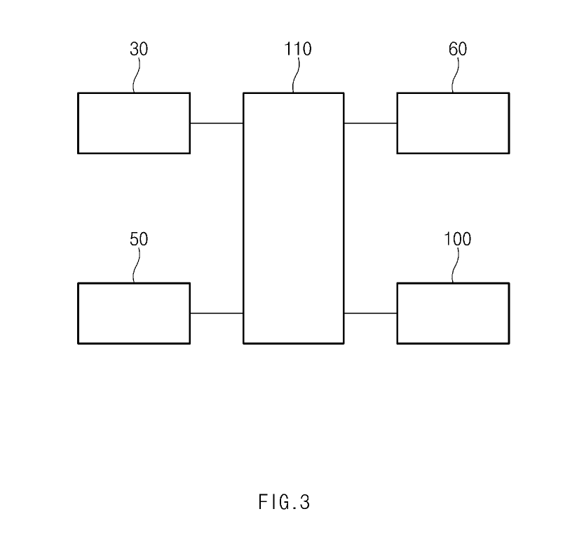

FIG. 2 is a flowchart illustrating a method for starting an engine, according to an embodiment of the present invention, and FIG. 3 is a block diagram illustrating a control system of the engine.

Referring to FIG. 2, according to an embodiment of the present invention, the method for starting the engine may include operations of determining whether an engine starting signal S1 is applied (S10), determining whether an engine 10 is stopped by measuring revolutions per minute (RPM) R1 of a crankshaft 70 through a crankshaft position detector (CKP) 100 when the engine starting signal S1 is determined as being applied (S20), and starting the engine 10 when the engine 10 is determined as being stopped (S30).

Operation S10 may be performed by determining whether the engine starting signal S1 is applied to an electronic control unit (ECU) 110. The engine starting signal S1 may include various engine signals, and the various engine signals may be applied to the ECU 110 as long as the engine signals are used for requesting to start the engine 10 through various members mounted in a vehicle.

For instance, operation S10 may be performed by determining whether a key 50 of the engine 10 is turned on (key on) when the key 50 of the engine 10 is in a turn-off state (key off). That is, the key-off state is applied to the ECU 110 in a form of an engine stopping signal S2, and the key-on state is applied to the ECU 110 in a form of an engine starting signal S1.

For example, operation S10 may be performed by determining whether a brake pedal 60 is released (brake-off) when the engine 10 enters an idle stop and go (ISG) mode.

The ISG mode refers to a mode in which, when the brake pedal 60 is in an on state such that the driving of a vehicle is stopped for a predetermined time, the on state of the brake pedal 60 is applied to the ECU 110 in a form of the engine stopping signal S2 to stop the engine 10. In the state of entering the ISG mode, when the brake pedal 60 is in an off state, the off state of the brake pedal 60 is applied to the ECU 110 in a form of the engine starting signal S1 to restart the engine 10. In the instant case, the sentence “the brake pedal 60 is in the on state” refers to that the brake pedal 60 is pressed, and the sentence “the brake pedal 60 is in the off state” refers to that the brake pedal 60 is released.

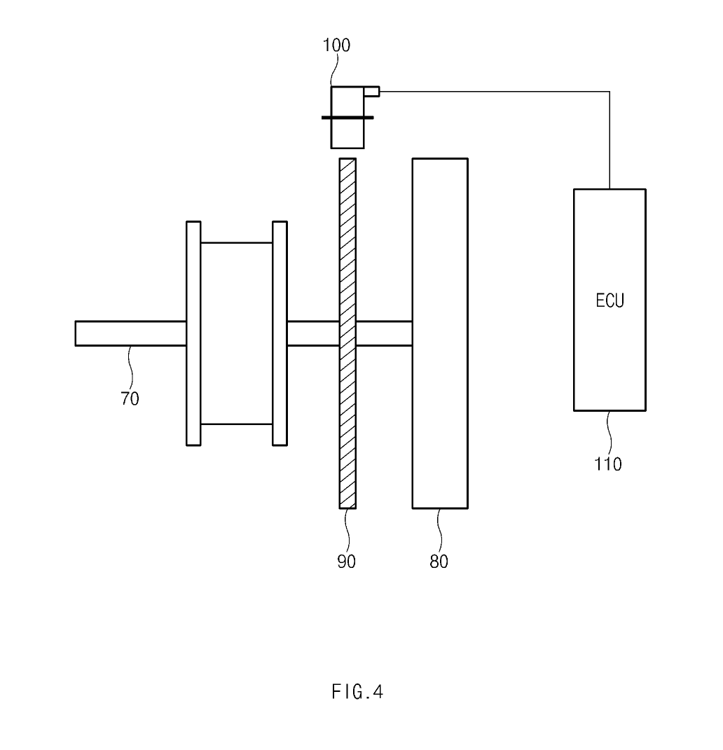

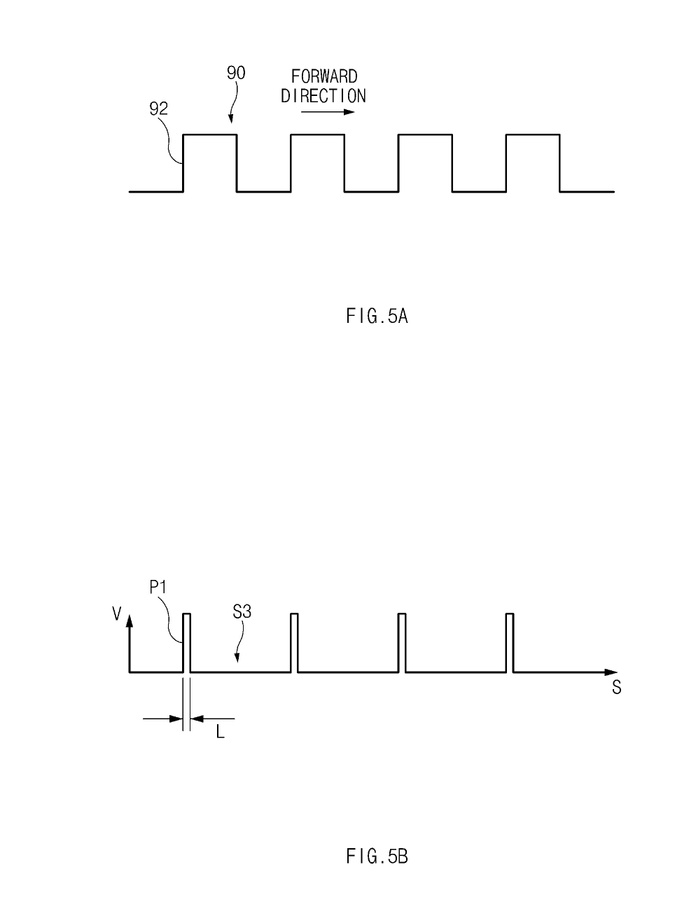

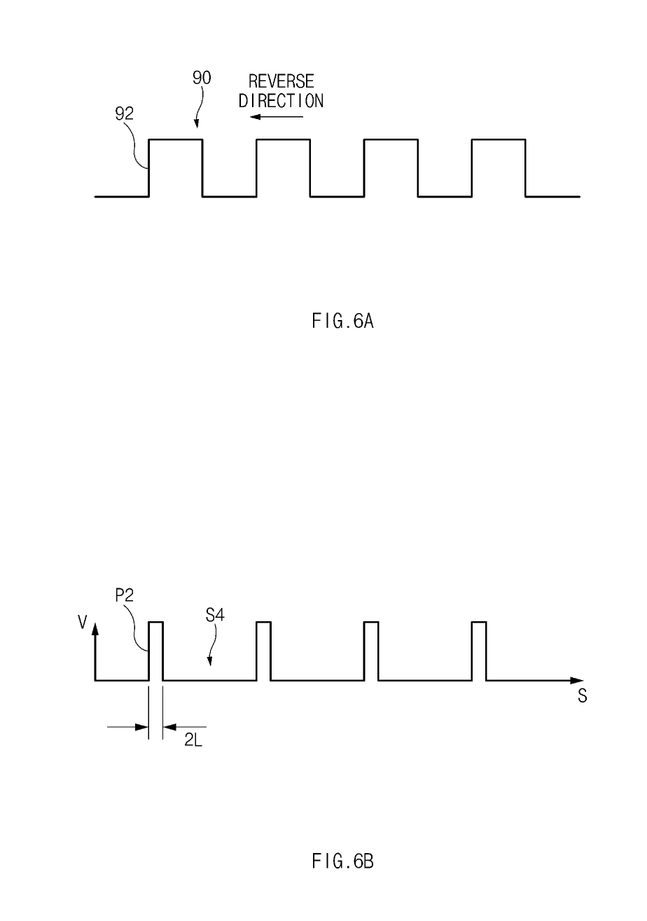

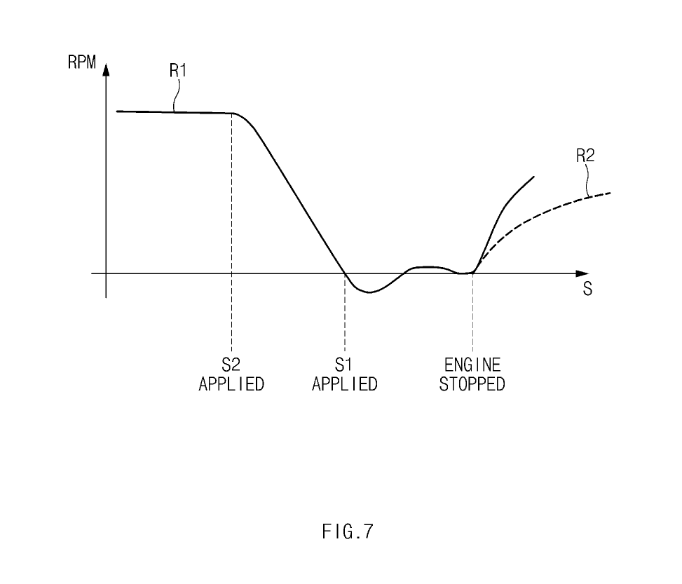

FIG. 4 is a sectional view illustrating a crank shaft position sensor, FIGS. 5A and 5B, and FIGS. 6A and 6B are views illustrating an operation of determining whether an engine is stopped, by use of the crank shaft position detector illustrated in FIG. 4, and FIG. 7 is a graph illustrating an aspect of starting the engine in the method for starting an engine, according to an embodiment of the present invention.

Next, as illustrated in FIG. 2, operation S20 may include an operation of determining whether the rotation of the crankshaft 70 is stopped by measuring a revolution per minute (RPM) R1 of the crankshaft 70 and a rotation direction through the crankshaft position detector 100 (S22) and an operation of standing by for a predetermined delay time Td (S24) when the crankshaft 70 is determined as being under rotation in operation S22.

As illustrated in FIG. 4, operation S22 may be performed by measuring the RPM of a detector wheel 90, which is mounted at the side of a flywheel 80 of the crankshaft 70, using the crankshaft position detector 100.

As illustrated in FIG. 5A, a plurality of teeth 92, or a plurality of slots (collectively, teeth 92) are provided at a predetermined interval on an external circumferential surface of the detector wheel 90. The detector wheel 90 includes a magnetic substance. The crankshaft position detector 100 is mounted to face the external circumferential surface of the detector wheel 90 as illustrated in FIG. 4.

The crankshaft position detector 100 outputs pulses P1 and P2 whenever any one of the teeth 92 of the detector wheel 90 passes through a position of facing the crankshaft position detector 100. The crankshaft position detector 100 outputs pulse signals S3 and S4 having a period proportional to the RPM R1 of the crankshaft 70 as illustrated in FIGS. 5B and 6B. In addition, the crankshaft position detector 100 may output the pulse signal S4 having a pulse width wide by a predetermined ratio when the rotation direction of the crankshaft 70 is a reverse direction, as compared to a pulse width when the rotation direction of the crankshaft 70 is a forward direction thereof. For example, as illustrated in FIGS. 5B and 6B, the crankshaft position detector 100 may output the pulse signal S3 having the pulse width of 1′ when the rotation direction of the crankshaft 70 is the forward direction, and may output the pulse signal S4 having the pulse width of ‘2L’ when the rotation direction of the crankshaft 70 is the reverse direction thereof. The engine ECU 110 may easily determine the rotation direction of the crankshaft 70 by use of the pulse width. Meanwhile, preferably, the forward direction refers to the rotation direction of the crankshaft 70 when a vehicle advances, and the reverse direction refers to the rotation direction of the crankshaft 70 when the vehicle reverses. However, the present invention is not limited thereto.

As described above, the pulse signals S3 and S4 output from the crankshaft position detector 100 are applied to the ECU 110. The ECU 110 may determine whether the engine 10 is stopped by measuring the RPM R1 of the crankshaft 70 and the rotation direction of the crankshaft 70, based on the pulse signals S3 and S4. For example, as illustrated in FIG. 7, the ECU 110 may determine whether the engine 10 is completely stopped by measuring the RPM R1 and the rotation direction of the crankshaft 70 when the engine starting signal S1 is applied within a predetermined time after the engine stopping signal S2 is applied. In the instant case, preferably, the case in which the engine 10 is completely stopped may refer to the case in which the RPM R1 of the crankshaft 70 is convergent to less than a reference RPM Rr and the rotation of the crankshaft 70 is actually stopped. However, the present invention is not limited thereto.

In operation S24, a standby state is maintained for a predetermined delay time of Td when the crankshaft 70 is determined as being under rotation in operation S22. In other words, when the crankshaft 70 is determined as being under a rotating operation in operation S22, the engine 10 is not started, but is maintained in the standby state by for the predetermined delay time of Td. Although the delay time of Td is preferably 50 ms, the present invention is not limited thereto.

Operations S22 and S24 may be repeatedly performed until the rotation of the crankshaft 70 is determined as being stopped in operation S22. In other words, the stop of the rotation of the crankshaft 70 is repeatedly determined at a time interval of the delay time of Td until the rotation of the crankshaft 70 is stopped.

Thereafter, operation S30 may be performed by starting the engine 10 when the rotation of the crankshaft 70 is determined as being stopped in operation S22. For example, when the rotation of the crankshaft 70 is determined as being stopped as illustrated in FIG. 7, operation S30 may be performed by rotating the starter motor 30 at a predetermined RPM of R2 after the pinion gear 40 of the starter motor 30 is engaged with the ring gear 20 of the engine 10.

According to an embodiment of the present invention, in the method for starting the engine, even though the engine starting signal S1 is applied, the engine 10 is not instantly started, but is started after the engine 10 is in a standby state until the engine 10 is determined as being completely stopped. Therefore, according to an embodiment of the present invention, the method for starting the engine may prevent the ring gear 20 of the engine 10 from colliding with the pinion gear 40 of the starter motor 30 as the engine 10 is started within a predetermine time after the engine stopping signal is applied, that is, while the crankshaft 70 is rotating due to inertia. Therefore, according to an exemplary embodiment of the present invention, the method for starting the engine may prevent noise from being caused by the collision between the ring gear 20 of the engine 10 and the pinion gear 40 of the starter motor 30 when the engine 10 is started, or may prevent the durability of the engine 10 and the starter motor 30 from being deteriorated.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for starting an engine, the method comprising:
determining whether an engine starting signal is applied;
determining whether the engine is stopped, by measuring a revolution per minute of a crankshaft through a crankshaft position detector when the engine starting signal is determined as being applied; and
starting the engine when the engine is determined as being stopped.

2. The method of claim 1, wherein the determining of whether the engine starting signal is applied includes determining whether a brake pedal is in an off state when the engine enters an idle stop and go mode.

3. The method of claim 1, wherein the determining of whether the engine starting signal is applied includes determining whether a key of the engine is switched to a key-on state, when the key of the engine is in a key-off state.

4. The method of claim 1, wherein the determining of whether the engine is stopped includes:
determining whether a rotation of the crankshaft is stopped, by measuring the revolution per minute of the crankshaft through the crankshaft position sensor; and
maintaining a standby state for a delay time when the crankshaft is determined as being under rotation.

5. The method of claim 4, wherein the determining of whether the rotation of the crankshaft is stopped includes:
determining the crankshaft as being stopped, when the revolution per minute of the crankshaft is less than a reference revolution per minute.

6. The method of claim 4, wherein the determining of whether the rotation of the crankshaft is stopped and the maintaining of the standby state for the delay time are repeatedly performed until the rotation of the crankshaft is determined as being stopped, and
wherein the starting of the engine is performed when the rotation of the crankshaft is determined as being stopped.

7. The method of claim 4, wherein the determining of whether the rotation of the crankshaft is stopped includes additionally measuring a rotation direction of the crankshaft through the crankshaft position sensor.

8. The method of claim 7, wherein the crankshaft position detector outputs a pulse signal having a period proportional to the revolution per minute, and
wherein the pulse signal output from the crankshaft position detector has a pulse width, which is formed when the rotation direction of the crankshaft is a reverse direction, wider than a pulse width which is formed when the rotation direction of the crankshaft is a forward direction thereof.

9. The method of claim 4, wherein the delay time is 50 ms.
